(19) United States
(12) Patent Application Publication
(10) Pub. No.: US 2004/0238293 A1
(43) Pub. Date: Dec. 2, 2004

(54) Retaining structure for pad holding pins of disc brakes

(76) Inventors: Mattia Regazzoni, Ponteranica (IT); Pierangelo Gherardi, Zogno (IT); Cristian Crippa, Almenno San Salvatore (IT); Mirko Castellana, Bergamo (IT)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/489,165

(22) PCT Filed: Sep. 14, 2001
(86) PCT No.: PCT/IT01/00480

(51) Int. Cl. F16D 55/08

(52) U.S. Cl. 188/72.1

(57) ABSTRACT

A disk brake (10) comprises a caliper body (14) and at least one pad-support pin (16) provided at least with ends (20, 22) which can be housed in seats (24, 26) of the caliper body (14). A resilient ring (30) can be fitted on the pin the resilient ring (30) is formed by a wire the ends of which are joined together and which is wound in a spiral forming the resilient ring (30). The spiral has dimensions such as to be housed in a portion (58) of one of the seats of the caliper body in a manner such as to exert a resilient reaction to a force to remove the pin from the seat of the caliper body. The pin comprises an annular seat (32) for housing the resilient ring (30).

The subject of the present invention is a disk brake for a vehicle.

As is known, a disk brake comprises a disk mounted on the hub of a wheel of the vehicle and a caliper arranged astride the disk. The caliper generally comprises a caliper body which houses the pads, and means for urging the pads against the disk in order to bring about the braking action on the vehicle.

In disk brakes of the type described briefly above, it is known to support the pads by means of pins housed in suitable seats formed in the caliper body and extending through suitable holes provided in the plates which support the friction linings of the pads.

In order to restrain the pins axially relative to the caliper body, it is known to use at least two possible methods, as described below.

In a first case, the axial restraint of the pins is achieved by means of split pins having at least one arm inserted in a suitable transverse hole of the pin.

In a second case, the axial restraint of the pins is achieved by the provision of a substantially “barrel”-shaped resilient element associated with an end of the pin, in a manner such that, in operation, the element is engaged in one of the seats of the caliper body by friction.

Both of the methods described above satisfy the requirement to achieve quick fitting of the pins, and hence of the pads, on the caliper body.

However, it should be borne in mind that neither of the above-described methods is free of disadvantages, as will be described below.

In the first case, that is, when the pins for supporting the pads are restrained on the caliper body by split pins and, in racing applications in particular, the split pin may not be repositioned or may be repositioned incorrectly after the pins have been removed in order to replace the pads.

This inevitably results in the pin slipping out of its seats in the caliper body and hence in the loss of the pads associated therewith, with the serious consequence of loss of the braking action.

In the second case, that is, when the pins supporting the pads are restrained on the caliper body by means of “barrel”-shaped resilient elements, the constructional clearances of the seat of the pin which houses the resilient element are such as to allow the pin to move axially.

When the vehicle is in use, these axial movements result in undesired and annoying noisiness of the brake.

The aim of the present invention is therefore to devise and to provide a disk brake which satisfies the above-mentioned requirement and at the same time overcomes the disadvantages mentioned with reference to the prior art.

This object is achieved by means of a disk brake according to claim 1.

Further characteristics and the advantages of the disk brake according to the invention will become clear from the following description of preferred embodiments, given by way of non-limiting example with reference to the appended drawings, in which:

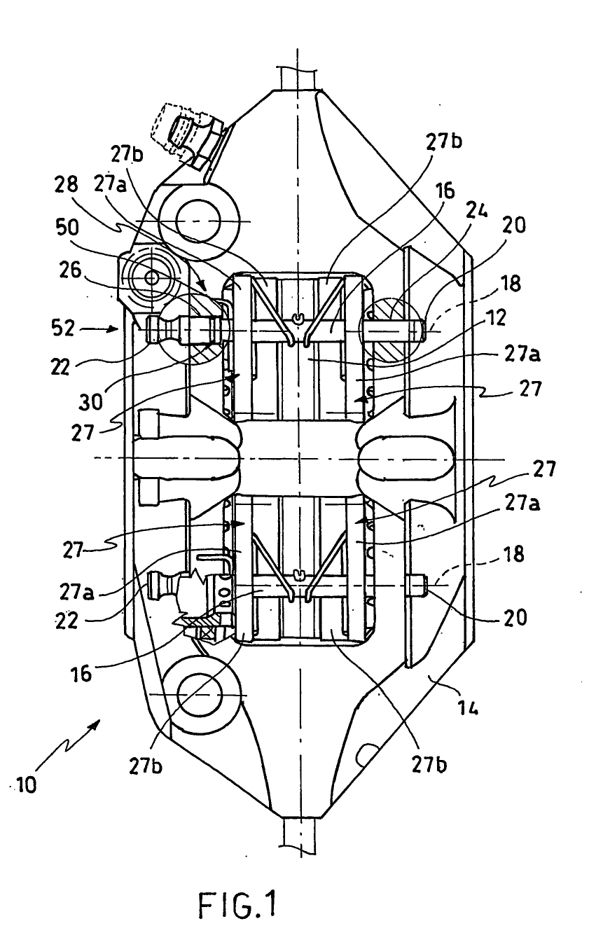

FIG. 1 is a partially-sectioned view of a possible embodiment of a disk brake according to the present invention,

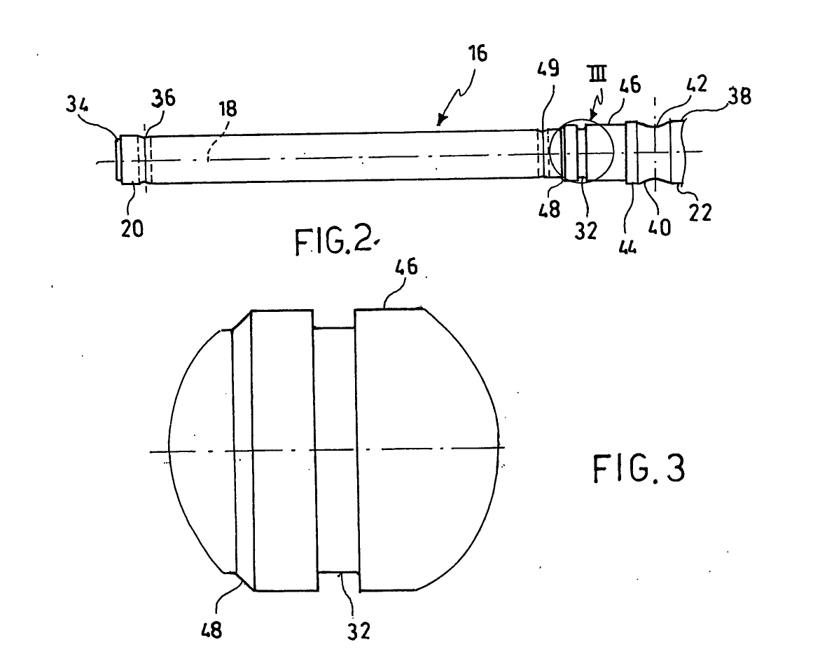

FIG. 2 is a front view of the support pin of the pads of the disk brake of FIG. 1,

FIG. 3 shows the detail III of FIG. 2,

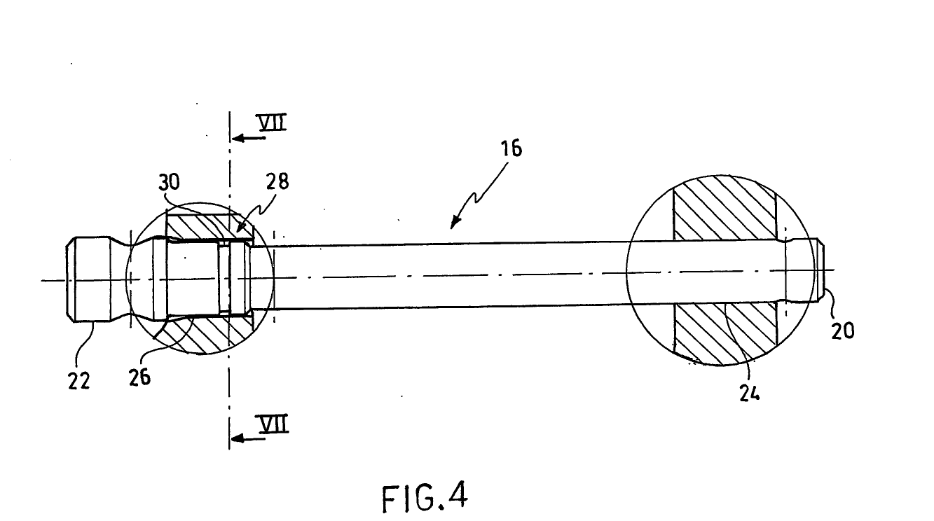

FIG. 4 shows an enlarged detail of FIG. 1 in which some elements have been omitted to show others,

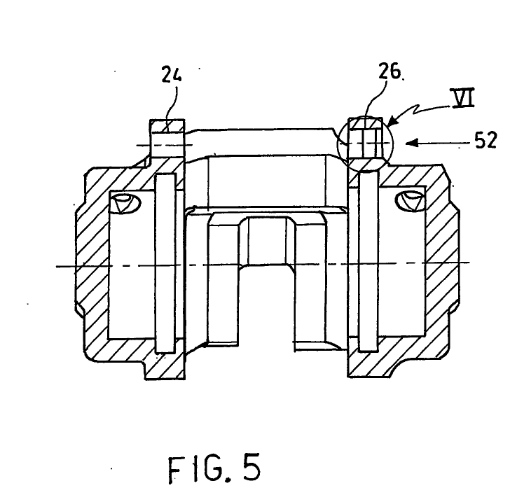

FIG. 5 shows a section through the caliper body of the brake of FIG. 1, taken in a plane extending through the axis of a pad-support pin,

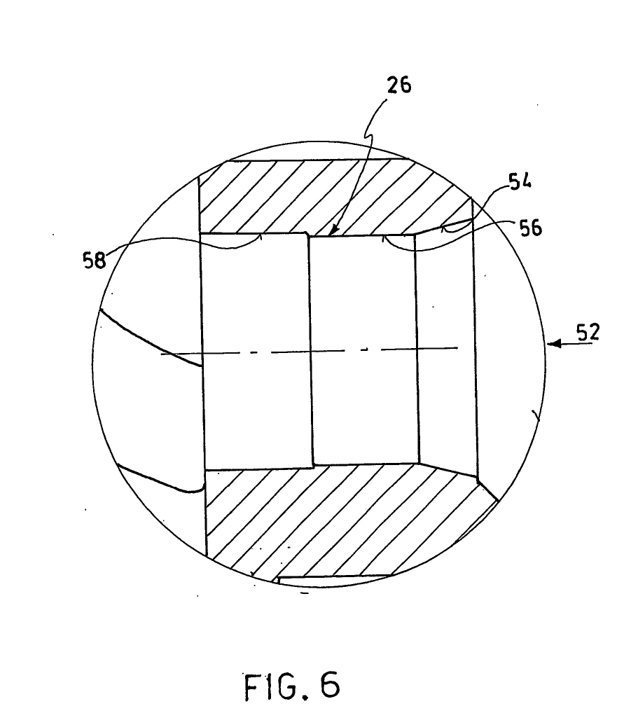

FIG. 6 shows the detail VI of FIG. 5 relating to one of the seats of the caliper body, on an enlarged scale,

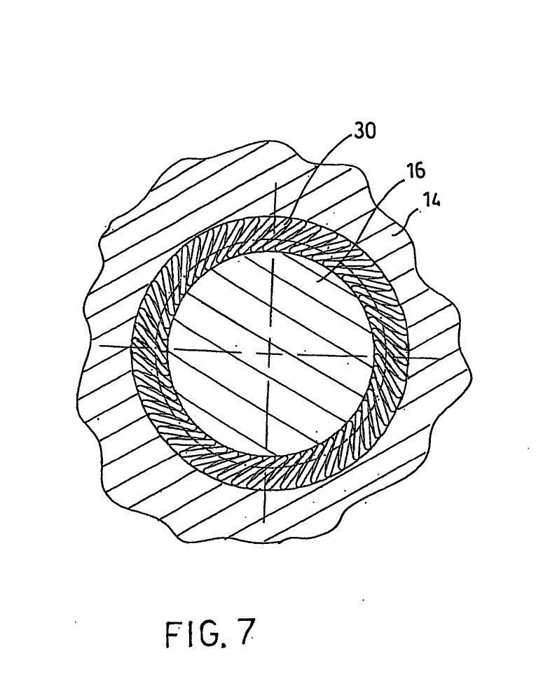

FIG. 7 shows a partial and enlarged cross-section taken on the line VII-VII of FIG. 4,

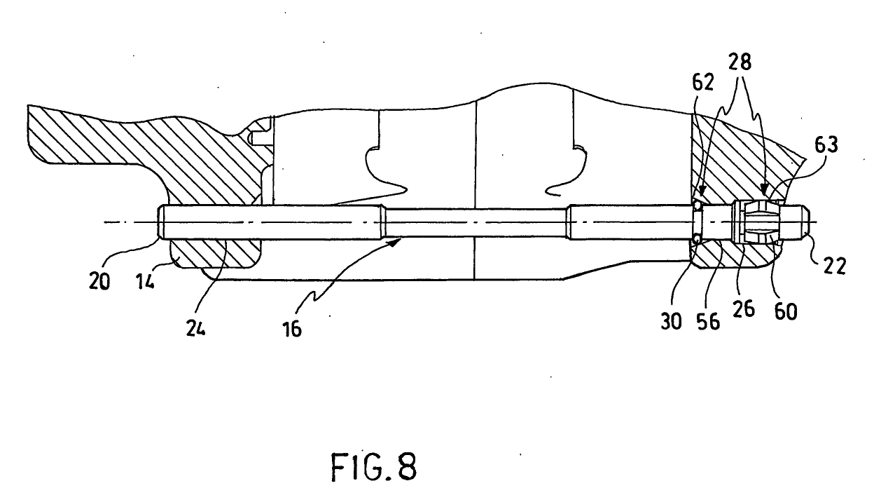

FIG. 8 shows a partial section through a caliper body of a disk brake according to one possible embodiment,

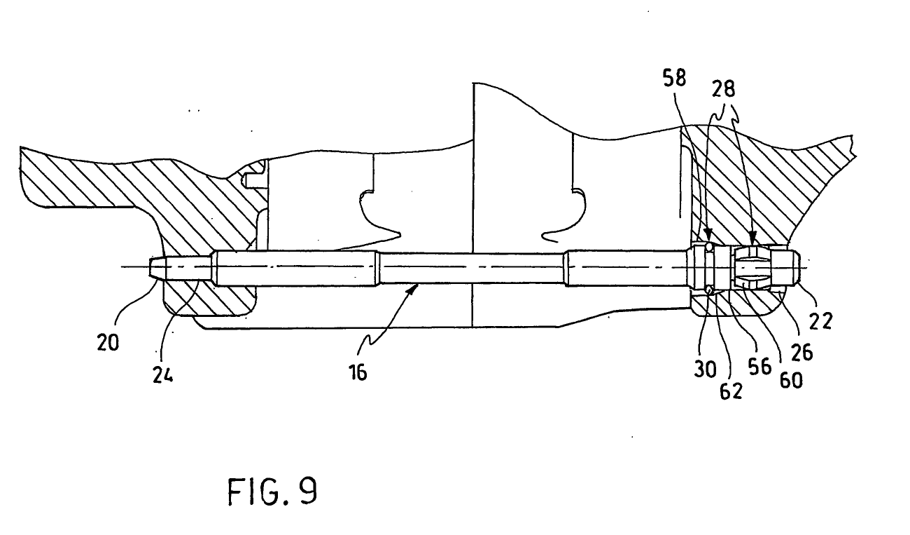

FIG. 9 shows a partial section through a caliper body of a disk brake according to a further possible embodiment, and

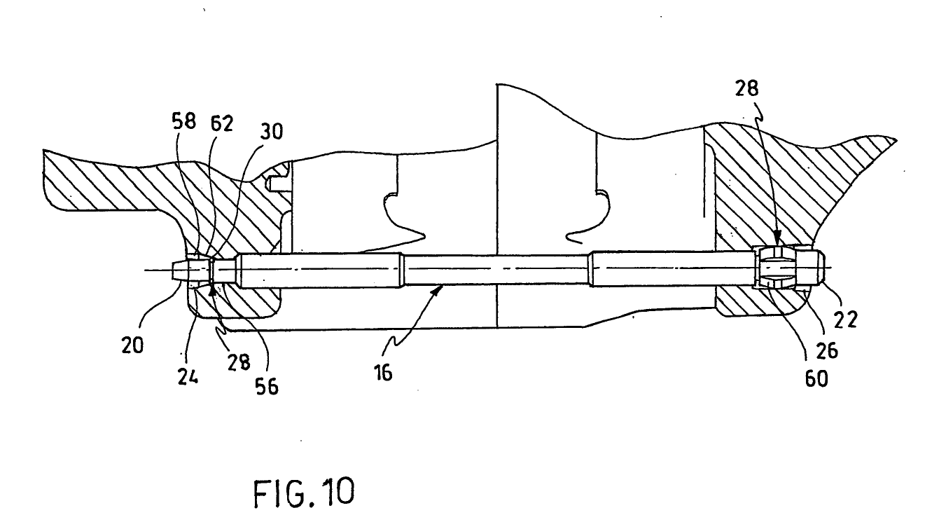

FIG. 10 shows a partial section through a caliper body of a disk brake according to a further possible embodiment.

With reference to the above-mentioned drawings, a disk brake for a vehicle according to the present invention is generally indicated 10.

A disk brake comprises, amongst other things, a disk 12 mounted on a hub of a vehicle wheel and a caliper body 14 mounted on a non-rotating portion, for example, the suspension, so as to be arranged astride the disk 12.

The caliper body 14 houses, transversely relative to the disk 12, pins 16 which extend along longitudinal axes 18. In particular, each pin 16 has ends 20 and 22 which can be housed in respective seats 24 and 26 formed in the caliper body 14.

The pins 16 support pads 27 and, in particular, extend through holes formed in plates 27a disposed on opposite sides of the disk 12. Each plate 27a supports a respective friction lining 27b of the pad 27 which is acted on by thrust means, which are known and are therefore not described in detail, and which operate on the pads simultaneously, pressing them against the disk and exerting the braking force on the vehicle.

Each pad-support pin 16 is restrained on the caliper body by restraining means 28 which advantageously comprise a resilient ring 30 fitted on the pin and interacting with one of the seats 24, 26 of the caliper body 14.

According to one possible embodiment, the resilient ring 30 comprises a wire which is wound in a spiral and is closed onto itself at least once. An example of a resilient ring 30 is shown in greater detail in FIG. 7. According to this embodiment, the resilient ring 30 is formed by a wire which is wound in a spiral and the ends of which are joined together to form a closed loop.

According to one possible embodiment of the invention, the resilient ring 30 is housed in an annular seat 32 formed in a portion of the pin 16. The annular seat 32 may be formed in the vicinity of one of the ends 20, 22 of the pin 16.

An advantageous embodiment provides for the depth (in a radial direction relative to the pin) of the annular seat 32 to be about 0.36-0.4 mm and for its length (in an axial direction relative to the pin) to be about 0.84-0.91 mm. The width of the spiral with the coils free (the dimension along the radial direction of the pin) is advantageously arranged to be about 0.64 mm so that the resilient ring 30 projects from the annular seat 32 by about 0.24-0.28 mm. In particular, the ratio between the projecting portion of the resilient ring 30 and the width of the spiral with the coils free is advantageously between 0.35 and 0.45.

FIG. 2 shows a possible embodiment of a support pin 16 according to the present invention.

The pin 16 has a substantially axially symmetrical structure with respect to the longitudinal axis 18. The end 20 or tip of the pin has a tapered surface 34, preferably chamfered at 45°, to facilitate the fitting of the pin, and a transverse hole 36.

The opposite end 22, which is also defined as the head of the pin, comprises, starting from the end portion of the pin, a first cylindrical portion 38, a concave portion 40 provided with a transverse hole 42, an annular projection 44 which delimits the concave portion 40, and a second cylindrical portion 46 in which the annular seat 32 is formed. The second cylindrical portion 46 terminates in a connecting surface 48, preferably inclined at 45°. FIG. 2 also shows a further transverse hole 49.

FIG. 3 shows the detail III of FIG. 2, which corresponds to the portion of the pin 16 which comprises the annular seat 32.

The pad-support pin 16 according to the present invention and, in particular, the means 28 for restraining it on the caliper body 14, also comprise further restraining elements which, according to one possible embodiment shown in FIG. 1, provide for a split pin 50 conventionally inserted with at least one arm in one of the transverse holes of the pin. This transverse hole may be either the transverse hole 36 formed in the tip or end 20 of the pin 16, or the transverse hole 49 formed in the head or end 22 of the pin 16, as shown in FIG. 1.

According to one possible embodiment, at least one of the seats 24, 26 of the caliper body 14 may be shaped as follows.

FIG. 6 shows the detail VI of FIG. 5 on an enlarged scale and shows a possible configuration of the seat 26 which houses the end 22 or head of the pin 16 and, in particular, the portion in which the annular seat 32 and the resilient ring 30 are provided. In the embodiment shown in FIG. 6, the seat described corresponds to the seat indicated 26 which houses the head of the pin 16. When, on the other hand, the resilient ring 30 is provided on the tip of the pin, the configuration shown in FIG. 6 will be that of the corresponding seat, that is, the seat indicated 24.

Starting from the outer side of the caliper body 14 and in a direction 52 corresponding to the direction in which the pad-support pin 16 is fitted, the seat 26 comprises an outwardly chamfered portion 54, a first cylindrical portion 56, and a second cylindrical portion 58 having a larger diameter than the cylindrical portion 56.

In the embodiment of FIG. 6, the change between the first cylindrical portion 56 and the second cylindrical portion 58 takes place by means of a step corresponding to the difference in diameter between the two portions.

When the pin 16 is inserted in the seats 24 and 26 of the caliper body 14 in the direction 52, the resilient ring 30 with which the pin is provided passes through the first cylindrical portion 56 which causes a predetermined flexure of the coils equal to about 25%. This means that the resilient ring 30 is influenced resiliently by the walls of the first portion 56 of the seat during the fitting of the pin 16.

When the resilient ring 30 is disposed in the region of the second cylindrical portion 58 having a larger diameter, the coils expand radially until they interact with the walls of the second cylindrical portion 58 of the seat 26 and the resilient ring 30 is snap-housed in the portion 58. In this condition, the coils may still have a flexure of about 10-15% or may be in the rest condition. In the first case, they help to stabilize the position of the pin in the seats during the operation of the vehicle.

Even if the split pin 50 is not fitted, the resilient ring 30 nevertheless restrains the pin 16 firmly in the seats in the caliper body 14.

The pin 16 is in fact prevented from slipping out of its seat, that is, the flexible resilient ring 30 is prevented from moving from the second cylindrical portion 58 to the first cylindrical portion 56 of smaller diameter, in the opposite direction to the direction 52, owing to the fact that the force necessary to flex the coils of the resilient ring again is never reached in operative conditions.

According to one possible embodiment, the pad-support pin 16 comprises further restraining elements in the form of “barrel”-shaped resilient elements 60 which engage in one of the seats of the caliper body 14 by friction. As shown in FIGS. 8 to 10, the “barrel”-shaped resilient element 60 is mounted on the end 22 or head of the pin 16.

In this embodiment, the flexible resilient ring 30 may be housed either on the same end 22 of the pin 16 which houses the “barrel”-shaped resilient element 60 (FIGS. 8 and 9), or on the opposite end 20 (FIG. 10).

According to one possible embodiment, the seat of the caliper body 14 which houses the end of the pin 16 on which the flexible resilient ring 30 is fitted comprises an abutment portion 62 disposed downstream of the first cylindrical portion 56 in the direction 52 of fitting of the pin 16. The flexible resilient ring 30 reacts against this abutment portion 62.

In FIG. 8, the seat 26 provides a portion 63 for housing the “barrel”-shaped element, the first cylindrical portion 56 and the abutment portion 62, which represents a portion having diameters larger than the diameter of the first cylindrical portion 56. In FIG. 9, the seat 26 provides both the first cylindrical portion 56 and the second cylindrical portion 58, between which the abutment portion 62 is interposed and, in this embodiment, also represents a portion having diameters larger than the diameter of the first cylindrical portion 56.

In FIG. 10, the seat 26 is shaped for housing the “barrel”-shaped element 60 and the seat 24 provides both the first cylindrical portion 56 and the second cylindrical portion 58, between which the abutment portion 62 is interposed and, in this embodiment, also represents a portion having diameters larger than the diameter of the first cylindrical portion 56.

In the embodiments of FIGS. 8 and 9, when the pin 16 is mounted on the caliper body 14, the resilient ring 30 with which it is provided is arranged reacting against the abutment portion 62 of the seat 26. In this condition, the flexible resilient ring 30 keeps the end of the pin 16 constantly in abutment with the resilient restraining element 60 (the “barrel”-shaped element) thus preventing axial movements of the pin.

The foregoing also occurs in the embodiment of FIG. 10, when the pin 16 is mounted on the caliper body 14. In this embodiment, the resilient ring 30 is arranged reacting against the abutment portion 62 of the seat 24, keeping the end of the pin 16 constantly in abutment with the resilient restraint element 60 and preventing axial movements of the pin.

In the case of the “barrel”-shaped element 60 also, when the pin 16 is inserted in the seats 24 and 26 of the caliper body 14 in the direction 52, the resilient ring 30 with which the pin is provided passes through the first cylindrical portion 56 which brings about a predetermined flexure of the coils, equal to approximately 25%. This means that the resilient ring 30 is influenced resiliently by the walls of the first portion 56 of the seat during the fitting of the pin 16.

When the resilient ring 30 is disposed in the region of the abutment portion 62, which constitutes a portion having transverse dimensions larger than the first portion 56, the coils expand radially until they interact with the walls of the abutment portion 62. In this condition, the coils may still have a flexure equal to about 10-20%, helping to stabilize the position of the pin in the seats when the vehicle is in operation.

It can be appreciated from the foregoing that the provision of a flexible resilient element as described above permits the introduction of a restraining means which, alone, can prevent the pin 16 from slipping out or, in conjunction with other restraint means, can help to restrain the pin in its seats, becoming a safety element.

This characteristic limits the risks connected with the replacement of the pads during which, when the pins are refitted, particularly in vehicles for sports applications, the split pin is not also refitted.

Moreover, by giving rise to a secure and stable restraint of the pin, particularly axially, the resilient ring 30 enables the pin to be kept in abutment, preventing axial movements thereof and consequently thus eliminating the noisiness of the brake due to the movements of the pin 16.

In addition to the foregoing, a further advantage is achieved in particular by the configuration which provides for the resilient ring 30 fitted on the tip or end 20 of the pin. In this case, simply by arranging for the two seats 24 and 26 to be similar, that is, to have respective first portions and second portions having transverse dimensions larger than the first portions, it is in fact possible to slip the pin out of the caliper body even only partially. In fact, the tip of the pin provided with the resilient ring 30 is slipped out of the seat 24 but not out of the seat 26 so that the pin remains temporarily anchored to the caliper body 14, without the need to be replaced, facilitating dismantling and reassembly operations.

Clearly, other variants and/or additions may be provided for the embodiments described and illustrated above.

For example, the split pin 50 provided in the case of the drawing of FIG. 1 may equally well be mounted in the vicinity of the head or of the tip of the pin 16.

Instead of being housed in an annular seat formed in the pin, the flexible resilient ring 30 may be housed in a seat in the caliper body 14. The portion projecting from the seat may advantageously have the same proportions as described above.

In order to satisfy contingent and specific requirements, a person skilled in the art may apply to the above-described preferred embodiments of the pin and of the caliper body, many modifications adaptations and replacements of elements with other functionally equivalent elements without, however, departing from the scope of the appended claims.

1. A disk brake comprising a disk, a caliper body, a pin for supporting pads, the pin having at least ends which can be housed in seats of the caliper body, and means for restraining the pin on the caliper body, wherein the restraining means comprise at least one flexible resilient ring which can be fitted on the pin and which is formed by a wire closed onto itself at least once and extending, wound in a spiral, forming the resilient ring, the spiral having dimensions such as to be housed in a portion of one of the seats of the caliper body in a manner such as to exert a resilient reaction to a force to remove the pin from the seat of the caliper body.

2. The disk brake according to claim 1 in which the flexible resilient ring is formed by a wire which is wound in a spiral and the ends of which are joined together.

3. The disk brake according to claim 1 in which the pin comprises an annular seat for housing the flexible resilient ring.

4. The disk brake according to claim 3 in which the ratio between a portion of the flexible resilient ring projecting from the annular seat and the width of the spiral with its coils free is between 0.35 and 0.45.

5. The disk brake according to claim 1 in which the flexible resilient ring of wire wound in a spiral is snap-housed in the portion of the seat of the caliper body.

6. The disk brake according to according to claim 1 in which the flexible resilient ring is influenced resiliently by walls of a portion of the seat of the caliper body during the fitting of the pin.

7. The disk brake according to claim 1 in which the means for restraining the pin on the caliper body comprise further restraining elements mounted on the same end of the pin which houses the flexible resilient ring.

8. The disk brake according to claim 1 in which the means for restraining the pin on the caliper body comprise further restraining elements mounted on the end of the pin remote from the end which houses the flexible resilient ring.

9. The disk brake according to claim 7 in which the further restraining elements comprise “barrel”-shaped resilient elements which engage by friction in one of the seats of the caliper body.

10. The disk brake according to claim 7 in which the further restraining elements comprise split pins inserted with at least one arm in a transverse hole of the pin.

11. The disk brake according to claim 1 in which at least one of the seats for housing the ends of the pin comprises at least a first portion and a second portion which has diameters larger than the diameter of the first portion and which can house the portion of the pin on which the flexible resilient ring is fitted, the second portion being disposed downstream of the first portion, with respect to a direction of fitting of the pin in the caliper body.

12. The disk brake according to claim 11 in which the first portion and the second portion are cylindrical, the second portion having a larger diameter than the first portion.

13. The disk brake according to claim 11 in which at least one of the seats comprises an abutment portion against which the flexible resilient ring fitted on the pin reacts.

14. The disk brake according to claim 13 in which the abutment portion comprises a chamfered surface disposed downstream of the first portion, with respect to a direction of fitting of the pin in the caliper body.

15. The pin 16 for supporting pads of a disk brake according to claim 2 in which the pin comprises an annular seat for housing the flexible resilient ring.

16. The disk brake according to claim 15 in which the ratio between a portion of the flexible resilient ring projecting from the annular seat and the width of the spiral with its coils free is between 0.35 and 0.45.

17. The disk brake according to claim 8 in which the further restraining elements comprise “barrel”-shaped resilient elements which engage by friction in one of the seats of the caliper body.

18. The disk brake according to claim 8 in which the further restraining elements comprise split pins inserted with at least one arm in a transverse hole of the pin.

19. The disk brake according to claim 12 in which at least one of the seats comprises an abutment portion against which the flexible resilient ring fitted on the pin reacts.

20. The disk brake according to claim 19 in which the abutment portion comprises a chamfered surface disposed downstream of the first portion, with respect to a direction of fitting of the pin in the caliper body.

21. The disk brake according claim 2 in which the flexible resilient ring of wire wound in a spiral is snap-housed in the portion of the seat of the caliper body.

22. The disk brake according claim 3 in which the flexible resilient ring of wire wound in a spiral is snap-housed in the portion of the seat of the caliper body.

23. The disk brake according claim 4 in which the flexible resilient ring of wire wound in a spiral is snap-housed in the portion of the seat of the caliper body.

24. The disk brake according to claim 2 in which the flexible resilient ring is influenced resiliently by walls of a portion of the seat of the caliper body during the fitting of the pin.

25. The disk brake according to claim 3 in which the flexible resilient ring is influenced resiliently by walls of a portion of the seat of the caliper body during the fitting of the pin.

26. The disk brake according to claim 4 in which the flexible resilient ring is influenced resiliently by walls of a portion of the seat of the caliper body during the fitting of the pin.

27. The disk brake according to claim 5 in which the flexible resilient ring is influenced resiliently by walls of a portion of the seat of the caliper body during the fitting of the pin.

28. The disk brake according to claim 2 in which the means for restraining the pin on the caliper body comprise further restraining elements mounted on the same end of the pin which houses the flexible resilient ring.

29. The disk brake according to claim 3 in which the means for restraining the pin on the caliper body comprise further restraining elements mounted on the same end of the pin which houses the flexible resilient ring.

30. The disk brake according to claim 4 in which the means for restraining the pin on the caliper body comprise further restraining elements mounted on the same end of the pin which houses the flexible resilient ring.

31. The disk brake according to claim 5 in which the means for restraining the pin on the caliper body comprise further restraining elements mounted on the same end of the pin which houses the flexible resilient ring.

32. The disk brake according to claim 6 in which the means for restraining the pin on the caliper body comprise further restraining elements mounted on the same end of the pin which houses the flexible resilient ring.

33. The disk brake according to claim 2 in which the means for restraining the pin on the caliper body comprise further restraining elements mounted on the end of the pin remote from the end which houses the flexible resilient ring.

34. The disk brake according to claim 3 in which the means for restraining the pin on the caliper body comprise further restraining elements mounted on the end of the pin remote from the end which houses the flexible resilient ring.

35. The disk brake according to claim 4 in which the means for restraining the pin on the caliper body comprise further restraining elements mounted on the end of the pin remote from the end which houses the flexible resilient ring.

36. The disk brake according to claim 5 in which the means for restraining the pin on the caliper body comprise further restraining elements mounted on the end of the pin remote from the end which houses the flexible resilient ring.

37. The disk brake according to claim 6 in which the means for restraining the pin on the caliper body comprise further restraining elements mounted on the end of the pin remote from the end which houses the flexible resilient ring.

38. A pin for supporting pads of a disk brake, comprising at least one flexible resilient ring which can be fitted on the pin and is made of a wire closed onto itself at least once and extending, wound in a spiral, forming the resilient ring, the spiral having dimensions such as to be housed in a portion of a seat of a caliper body in a manner such as to exert a resilient reaction to a force to remove the pin from the seat of the caliper body.

39. The kit for the maintenance of a disk brake, comprising a pin having the characteristics according to claim 38.

40. A caliper body of a disk brake comprising seats for housing at least one pin for supporting pads, wherein at least one of the seats comprises at least a first portion and a second portion which has diameters larger than the diameter of the first portion and which can house the portion of the pin on which the flexible resilient ring is fitted, the second portion being disposed downstream of the first portion, with respect to a direction of fitting of the pin in the caliper body.
